(19) United States
(12) Patent Application Publication
(10) Pub. No.: US 2002/0130199 A1
(43) Pub. Date: Sep. 19, 2002

(54) Atomizer for internal combustion engine liquids

(76) Inventor: Barry L. Holtzman, Eagle River, WI (US)

Correspondence Address: BARRY L. HOLTZMAN, 3907 EVERGREEN RD., EAGLE RIVER, WI, 54521, US

(21) Appl. No.: 09/812,337

(22) Filed: Mar. 19, 2001

(51) Int. Cl. B05B 3/16

(52) U.S. Cl. 239/382

(57) ABSTRACT

An atomizer for a liquid delivered to an internal combustion engine uses a nozzle positioned such that a substantial portion of the liquid which exits the nozzle will come in contact with the moveable member of an engine induction tract one-way valve. This one-way valve is preferably a reed valve, the moveable member being a reed. The reed or other moveable member has a rapid movement in response to engine operation. When the liquid comes in contact with the rapidly moving reed or other moveable member, it is broken into a mist of relatively fine droplet size. This invention is ideally suited when the liquid is a lubricating oil being delivered to an engine wherein there is minimal fuel in its induction tract or crankcase to thin and spread the lubricating oil to its necessary locations in the engine. It is also useful when the liquid is a fuel, breaking the fuel into smaller droplet size which is more suitable for combustion.

### BACKGROUND

1. Field of Invention

This invention is an atomizer which is used to convert a liquid into a mist for use in an internal combustion engine. This atomizer contains a nozzle which is used to inject a liquid, primarily either a lubricating oil, a fuel, or fuel/oil mixture, this nozzle being positioned such that a substantial portion of the injected liquid comes in contact with a moving part of an induction tract one-way valve, normally the moving reed petal of a reed valve. The rapid high speed movement typically found in these parts, typically a reed, facilitates the breaking up of the liquid into a relatively fine droplet mist, these droplets then being advantageously positioned to be carried into the engine by the incoming air passing through the valve.

2. Description of Prior Art

Many internal combustion engines, primarily two-stroke cycle engines, have a total loss oil lubrication system, meaning the lubricating oil goes through a crankcase and then eventually into an engine cylinder. It is present at combustion, then exits the engine through an exhaust port. In some cases the oil is pre-mixed with the fuel, the fuel being beneficial in that it dilutes and thins the oil. The fuel/oil mixture is picked up in the incoming air, and the resulting fuel/oil air mixture progresses through the engine crankcase and then into the engine cylinder, the oil present in the mixture lubricating the various rings, bearings, and other moving parts. In another system, called oil injection, the oil is automatically delivered by a pump which pumps a metered amount of oil depending on engine operating conditions such as throttle position and engine speed in revolutions per minute (RPM). In a simple oil injection system, the oil is merely pumped into the fuel where the oil distribution is similar to that which occurs with a pre-mix system. Sometimes the oil is injected somewhere in the engine intake tract where it then mixes with the incoming fuel (and air) and is distributed into the crankcase and cylinders. Some systems supplement this simple system by adding injection points directly at some critical moving parts, such as main crankshaft bearings. These systems are well known in the art.

Engine cylinder scavenging is the process wherein residuals from the previous combustion process are purged from the cylinder and replaced with fresh fuel and air for the next combustion process. Especially in two-stroke cycle engines with no effective exhaust port, some of the fresh fuel and air is lost out the exhaust port during the scavenging process; this process of losing unburned fuel is called short-circuiting. Environmental and fuel economy considerations are prompting efforts to reduce this fuel short-circuiting. One method of reducing this fuel loss involves introducing the fuel directly into the cylinder after the exhaust port has closed, called direct cylinder injection. Another method involves placing the fuel strategically in one or more of the cylinder transfer ports, called transfer port injection. These are well known in the art.

Both direct injection and transfer port injection result in essentially an absence of fuel in the engine's induction tract and crankcase. This presents a problem for the traditional oil lubrication systems discussed above which rely on the fuel to help carry the oil through the crankcase and into the cylinder. It has been found that injecting oil into the induction tract without substantial fuel present, only having incoming air to dilute and disperse the oil, results in inferior distribution and hence inferior lubrication. In cold weather operation this is an even greater problem because the oil dispersal is lessened by the oil's increased viscosity.

Two-stroke cycle engines do not normally have any cylinder intake valves. Especially for these engines, it has been found advantageous to provide a one-way valve in the engine induction tract. This one-way valve provides ready entrance of intake charge (air, fuel, oil, or any combination of these) normally into the engine crankcase, while substantially reducing the opportunity for its exit. This one-way valve can take many forms, but the design which is most commonly used contains multiple reed petals in its construction and is called a reed valve. These reed petals readily bend in response to a forward pressure difference, opening the reed valve and allowing charge entrance into the engine. These petals, however, due to their elasticity and due to an induction tract pressure change, rapidly return to a closed position, essentially preventing appreciable charge exit from the engine. The use of reed valves in the induction tract of an engine is well known in the art. U.S. Pat. No. 5,092,288 to Staerlz (1992) describes an induction tract reed valve which has a fuel rail at the apex of the reed cage with fuel injection points directed into the interior of the reed valve in an area of high speed incoming air flow. This invention uses this high incoming air speed to atomize the fuel, but because the injection ports are located near the ends of the reeds and because of the high air velocity in the vicinity of the injection, little if any of the fuel actually comes in contact with the moving reed petals. Also, increased manufacturing complexity and cost results from the installation of the fuel rail in the reed cage and the external connection of the fuel supply to this fuel rail.

### OBJECTS AND ADVANTAGES

It is an object of this invention to provide an atomizer for a liquid which is injected into an internal combustion engine, this atomizer using a nozzle positioned in order that essentially all of the injected liquid comes in contact with a moving member of an induction tract one-way valve, normally a reed of a reed valve. This contact with the moving member, normally a reed petal, causes the liquid to break down into a mist of smaller droplet size. This atomizer is ideally suited for engine lubricating oil as it provides a relatively smaller droplet oil mist for improved dispersal by the incoming charge (fuel, air, or fuel/air mixture) which passes through the valve. It is also ideally suited for use with engine fuel itself, or a mixture of engine fuel and lubricating oil, as the smaller droplet size in the fuel or fuel/oil mist is an aid in combustion as well as lubrication. The construction cost of this atomizer is minimal.

Still further objects and advantages will become apparent from a consideration of the ensuing description and drawing.

### DRAWING FIGURE

FIG. 1 shows a cross-sectional view of an embodiment of an atomizer of this invention, taken in a plane containing the axis of the engine induction tract.

### REFERENCE NUMERALS IN DRAWINGS

5 engine induction tract assembly

10 engine crankcase

12 inlet to engine crankcase

14 engine crankcase reed block

20 throttle assembly

21 throttle body

22 throttle plate

24 throttle bore

26 boot

30 reed valve assembly

32 reed cage

33 reed cage openings

34 reed petal in closed position

34′ reed petal in open position

36 reed guard plate

37 reed guard plate opening

38 reed petal and guard plate attaching rivet

40 injection nozzle

42 injection nozzle orifice

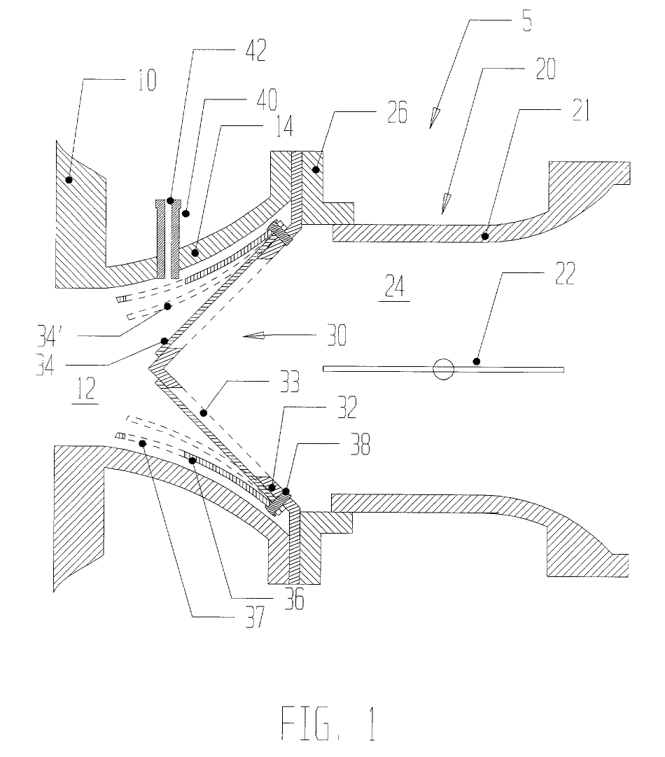

### DESCRIPTION AND OPERATING—FIG. 1

FIG. 1 shows an engine induction tract assembly 5 connected to a partially shown engine crankcase 10. Induction tract assembly 5 is connected to an inlet 12 of crankcase 10 by attachment to a reed block 14 which is normally part of the casting of crankcase 10. Induction tract assembly 5 contains a throttle assembly 20 and a reed valve assembly 30. Throttle assembly 20 contains a throttle body 21, a throttle 22 which controls the flow of air in bore 24, and a boot 26 used to connect throttle assembly 20 to reed block 14. Reed valve assembly 30 contains a reed cage 32 with reed cage openings 33, reed petals shown in their closed position as 34 and in an open position as 34′, optional reed guard plates 36 with guard plate openings 37, and attaching rivets 38 which rigidly clamp the ends of reed petals 34 between optional guard plates 36 and reed cage 32. Reed assembly 30 is held in reed block 14 by bolts, not shown, which hold boot 26 to reed block 14. An injection nozzle 40 with an orifice 42 is shown passing through reed block 14 with the end of orifice 42 being positioned above an opening in optional reed guard plate 36 and above a reed petal 34.

Operation of FIG. 1 is as follows. The upward motion of an engine piston, not shown, in an engine cylinder, not shown, reduces the pressure in engine crankcase 10; the downward motion of the engine piston increases the pressure in crankcase 10. The motion of the engine piston therefore causes positive and negative pressure waves to occur in crankcase 10. When a negative pressure exists in crankcase 10, a force is exerted on reed petals 34 causing them to open in a direction shown by reed petals 34′. In normal operation, their movement is limited by their elasticity, and sometimes to prevent reed damage, guard plates 36 are used to limit reed 34′ maximum movement. This allows air, and sometimes fuel, to enter throttle assembly 20, flow through the openings 33 in reed cage 32, and enter crankcase 10 through inlet 12. When the pressure inside crankcase 10 starts to increase, the elasticity of reed petals 34′ forces a movement to the closed position, this closing force subsequently aided by a positive pressure which eventually exists in crankcase 10 caused by the descending motion of the engine piston. Therefore, in summary, as the pressure in crankcase 10 decreases below the pressure outside throttle assembly 22, reed petals 34 move to some open position shown by petals 34′, and as the pressure in crankcase 10 begins to increase, petals 34′ “snap back” to the closed position 34 due to their elasticity and external pressure forces.

This opening and closing of reed petals 34 occurs every cycle of engine rotation of a two-stroke cycle engine, and petal 34 motion can attain speeds in excess of 500 cm/sec. Also of importance to this invention is that reeds 34, when disturbed, also “flutter”, or oscillate, at their natural frequency, this natural frequency being in the order of 50,000 cycles per second (cps).

A liquid is delivered to nozzle 40 through a suitable conduit, not shown, by a suitable delivery system, not shown. In the case of engine lubricating oil, the delivery is accomplished using an oil pump which delivers the proper metered oil quantity based on engine operating conditions. In the case of fuel or fuel/oil mixture, the delivery could be accomplished by a suitable fuel injection system, for instance, also responsive to engine operating conditions. One such fuel injection system is described in applicant's co-pending application Ser. No. 09/550774. This liquid enters the engine through orifice 42, and since orifice 42 has its outlet end positioned directly above guard plate hole 37 in optional guard plate 36 and reed petal 34 and 34′, the liquid necessarily drops on reed petal 34. The movement of reed petal 34, both translational movement caused by pressure forces and superimposed oscillatory movement at its natural frequency, imparts energy to the liquid, causing it to break up into a mist of fine droplets.

This placement of nozzle 40 also is naturally advantageous for dispersal of the liquid, after being broken up into a fine droplet mist, into the incoming air to the engine. This is due to the fact that the incoming air velocity is high at the end of reed petal 34′, and the mist, after it passes the end of petal 34′, is readily picked up by air flowing past the end of reed petal 34′ for distribution in the engine.

In summary, liquid is injected through orifice 42, it falls through an opening 37 in guard plate 36, if present, and lands on reed petal 34. The motion of reed petal 34 breaks the liquid into finer droplets, it then proceeds past the end of reed 34 (or 34′) where it is readily picked up by the high speed air flow past the end of reed petal 34′.

### SUMMARY, RAMIFICATION, AND SCOPE

Accordingly, the reader will see that this invention provides a low cost method of liquid atomization which improves the distribution of the liquid to an engine, especially in oil injection applications where fuel is not available for oil dispersal.

Although the description above contains many specificities, these should not be construed as limiting the scope of the invention but as merely providing illustrations of some of the presently preferred embodiments of this invention. For instance, one nozzle is shown dropping liquid on one of normally several reed petals; more than one nozzle can drop liquid on more than one reed petal. Also, other forms of induction valves exist, such as spring-loaded poppet valves, and this invention could readily be adapted to these other valve types. Thus, the scope of the invention should be determined by the appended claims and their legal equivalents, rather than by the examples given.

I claim:

1. An atomizer for a liquid delivered to an engine, said engine including:
an induction tract with a flow having an inward direction and an outward direction relative to said engine,
said induction tract including a valve containing a moveable member having a first position which restricts flow in said outward direction and a second position which allows relatively unrestricted flow in said inward direction,
and said atomizer including:
an orifice with an outlet,
said outlet in said orifice having a location whereby a substantial portion of said liquid necessarily comes in contact with said moveable member in said valve, whereby said liquid is broken into relatively smaller droplet size by motion of said moveable member in said valve.

2. The atomizer of claim 1. wherein said valve is a reed valve and said moveable member is a reed petal.

3. The atomizer of claim 1. wherein said liquid is lubricating oil.

4. The atomizer of claim 1. wherein said liquid is a fuel.

5. The atomizer of claim 1. wherein said liquid is a mixture of lubricating oil and a fuel.

6. The atomizer of claim 1. wherein said induction tract contains essentially no fuel and said liquid is a lubricating oil.

7. The atomizer of claim 1. wherein said opening in said nozzle is protected from said flow in said inward direction relative to said engine.
